(19) United States
(12) Patent Application Publication
(10) Pub. No.: US 2018/0291966 A1
(43) Pub. Date: Oct. 11, 2018

(54) FRICTION ELEMENT FOR TRANSMISSION

(71) Applicants: HYUNDAI MOTOR COMPANY, Seoul (KR); KIA MOTORS CORPORATION, Seoul (KR)

(72) Inventors: Seong Eun YUN, Bucheon-si (KR); Tae Seok SEO, Hwaseong-si (KR); Jin Haeng LEE, Hwaseong-si (KR)

(73) Assignees: HYUNDAI MOTOR COMPANY, Seoul (KR); KIA MOTORS CORPORATION, Seoul (KR)

(21) Appl. No.: 15/797,666

(22) Filed: Oct. 30, 2017

(30) Foreign Application Priority Data
Apr. 10, 2017 (KR) 10-2017-0045985

(51) Int. Cl. F16D 13/68; F16D 13/52; F16D 13/70

(52) U.S. Cl. CPC F16D 13/683; F16D 13/70; F16D 13/52

(57) ABSTRACT

The present disclosure relates to a technology which effectively absorbs a gear shifting impact by sequential fastening discs or plates to one another by a friction element. The friction element includes: a multi-plate disc set having discs and/or plates, and a fastening device having springs. In particular, the springs may start to be compressed from a spring having the smallest spring constant to a spring having a greater spring constant so as to sequentially fasten the discs and plates to one another so that the amount of a change in a stroke of a piston with respect to a change in an operation force of the piston is sequentially reduced.

### CROSS REFERENCE TO RELATED APPLICATION

This application claims priority to and the benefit of Korean Patent Application No. 10-2017-0045985, filed Apr. 10, 2017, which is incorporated by reference in its entirety.

### FIELD

The present disclosure relates to a friction element for a transmission.

### BACKGROUND

The statements in this section merely provide background information related to the present disclosure and may not constitute prior art.

In a vehicle having an automatic transmission installed therein, a torque converter transfers rotation power generated by an engine to the transmission and the transmission transfers the rotation power of the engine to a driving shaft through appropriate gear shifting.

Such a transmission has a gear unit installed therein, which includes multiple gear elements. The gear unit selectively outputs the rotation of the gear elements through a friction element, such as a clutch or a brake. In this event, the rotation of the gear elements may be output through gear shifting to a gear (position) suitable for the running situation of the vehicle.

Meanwhile, friction elements installed in an automatic transmission are configured to have a structure of a multi-plate disc set (multi-plate clutch) normally using hydraulic pressure, and this multi-plate disc set is connected to rotation elements of a planetary gear device.

In other words, discs and plates, included in the multi-plate disc set, are fastened to or released from one another by the operation of a piston by hydraulic pressure. Therefore, rotation power of a driving force is selectively output through the planetary gear device.

In this configuration, a cushion spring may be mounted between the disc set and the piston and may reduce an impact generated during the operation of the piston.

In other words, in an operation area of the cushion spring, the amount of a change in the stroke of the piston with respect to an operation force of the piston is reduced to enable smooth fastening of the discs, thereby reducing an impact due to fastening of the piston.

However, we have discovered that the cushion spring is arranged to have a relatively greater spring constant in order to improve the sense of gear shifting by reducing an impact caused by piston fastening. Further, the spring constant is not changed even in increasing and decreasing of the operation force of the piston. Therefore, the cushion spring is insufficient to improve the sense of gear shifting.

The above information disclosed in this Background section is only for enhancement of understanding of the background of the present disclosure and should not be taken as acknowledgement that this information forms the prior art that is already known to a person skilled in the art.

### SUMMARY

The present disclosure provides a friction element for a transmission, which more effectively absorbs a gear shifting impact by making discs and plates be sequentially fastened to one another in a multi-plate disc set.

In one form of the present disclosure, the present disclosure may include: a multi-plate disc set configured to vary in frictional force between a plurality of discs and a plurality of plates based on operation of a piston; and a sequential fastening means configured to sequentially fasten the plurality of discs and the plurality of plates based on the operation of the piston.

The sequential fastening means may include spring elements respectively installed between neighboring discs of the plurality of discs or between neighboring plates of the plurality of plates, and the spring elements may have different spring constants.

Each of the spring elements may have ends respectively supported by facing sides of two plates of the neighboring plates.

Each of the spring elements may have ends respectively supported by facing sides of two discs of the neighboring discs.

The spring elements may be arranged in an uncompressed state so that gaps between plates are uniform in a state in which an operation force of the piston is not transferred to the multi-plate disc set.

Through the above-described solution, spring elements are compressed beginning from a spring element having the smallest spring constant so that discs and plates are sequentially fastened to one another, and thus the amount of a change in the stroke of a piston with respect to an increase in an operation force of the piston becomes sequentially smaller whenever the discs and the plates are fastened to one another. Therefore, the present disclosure improves the sense of gear shifting by absorbing a gear shifting impact caused by disc fastening.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates the internal structure of a transmission to which a friction element of the present disclosure can be applied;

FIG. 2 conceptually illustrates the installation state of a spring element installed in a friction element in one form of the present disclosure; and

FIG. 3 is a view for describing an operation relationship between the stroke and operation force of a piston with respect to spring elements in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A friction element for a transmission in one form of the present disclosure may include a multi-plate disc set 1 and a sequential fastening means.

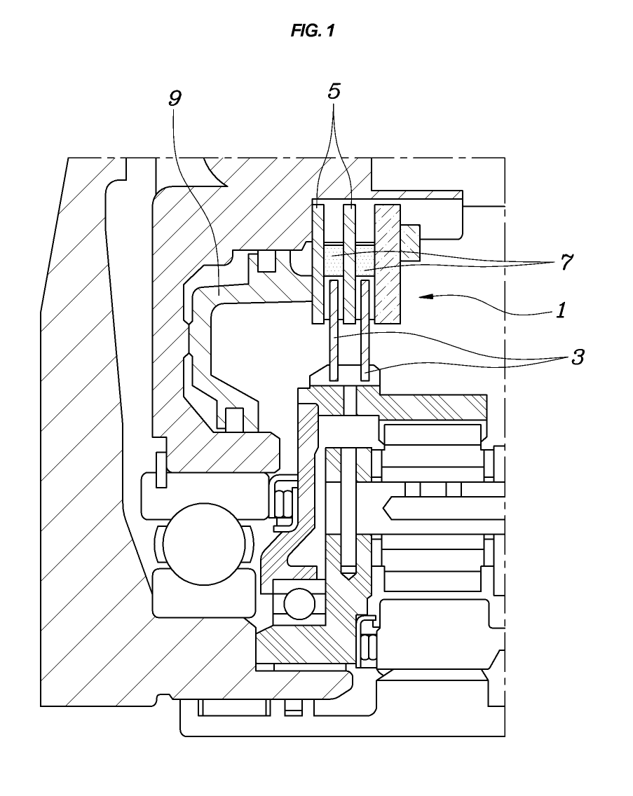

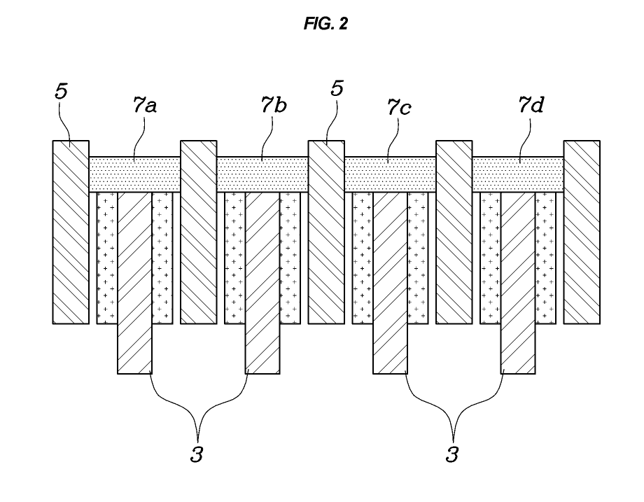

Referring to FIGS. 1 and 2, first, the multi-plate disc set 1 is formed to be changed in frictional force between a plurality of discs 3 and a plurality of plates 5 based on the operation of a piston 9. For example, the multi-plate disc set 1 may be a clutch or a brake arranged as friction elements in an automatic transmission.

The sequential fastening means of the present disclosure may be configured to fasten the discs 3 and the plates 5 sequentially according to the operation of the piston 9.

As one form, the sequential fastening means may be implemented by spring elements 7 installed between neighboring discs 3 or between neighboring plates 5, while the spring elements 7 have different spring constants.

More specifically, with reference to FIG. 2, the spring elements 7 may be installed between the neighboring plates 5. In one form, the spring elements 7 may include a first spring 7a, a second spring 7b, a third spring 7c, and a fourth spring 7d, and the first spring to the fourth spring may have different spring constants.

However, the first spring to the fourth spring may be assembled and installed regardless of the spring constants.

According to the configuration described above, when a pressing operation force is provided to the multi-plate disc set 1 by the operation of the piston 9, a spring element 7 (e.g., 7a) having the smallest spring constant starts, first, to be compressed and then other spring elements 7 (e.g., 7b, 7c, 7d) are sequentially compressed according to the level of spring constants thereof. Thus, the discs 3 and the plates 5 may be sequentially fastened to one another.

As a result, whenever the discs 3 and the plates 5 are fastened to one another, the amount of a change in the stroke of the piston 9 with respect to an increase in an operation force of the piston 9 sequentially decreases, while more effectively absorbing a gear shifting impact due to the fastening of the discs 3, and thus the sense of a gear shifting is enhanced.

In addition, referring to FIG. 2, each of the spring elements 7 (i.e., 7a, 7b, 7c, 7d) may be installed such that both ends of each of the spring elements 7 are supported by facing sides of two neighboring plates 5, respectively.

In other words, the spring elements 7 may be installed at the facing sides of the plates 5, respectively, so that there is no interference of the discs 3.

Further, although not illustrated in the drawings, each of the spring elements 7 may be installed such that both ends of each of the spring elements 7 are supported by facing sides of two neighboring discs 3, respectively.

In other words, the spring elements 7 may be installed at the facing sides of the discs 3, respectively, so that there is no interference of the plates 5.

Herein, the spring elements 7 may have the function and structure of a compression spring.

Meanwhile, spring constants of the spring elements 7 are formed to be different. However, it is recommended that the spring elements 7 are installed so that gaps between the plates 5 are identical when the piston 9 does not operate.

To this end, the present disclosure may include the spring elements 7 arranged in an uncompressed state so that gaps between the plates 5 are uniform in a state in which an operation force of the piston 9 is not transferred to the multi-plate disc set 1.

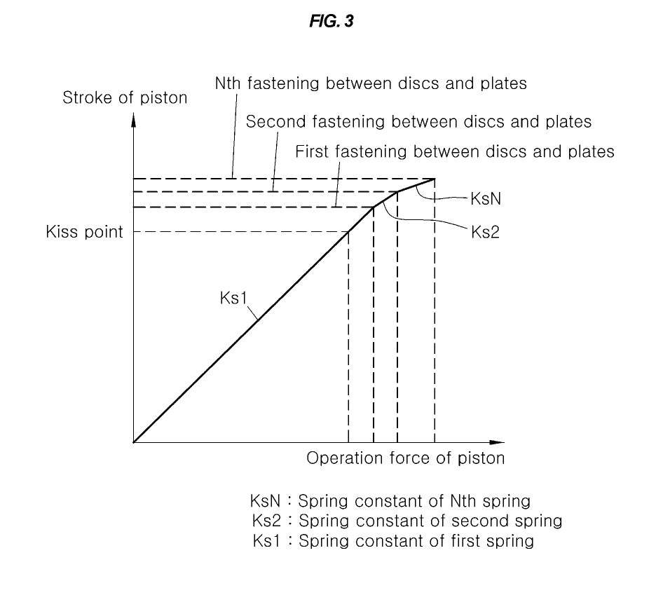

In addition, referring to FIG. 3, in the present disclosure, load (pressure) may be a kiss point load (e.g., approximately 1 bar) when the discs 3 and the plates 5 are first fastened according to the compression of the spring element 7 having the smallest spring constant in the multi-plate disc set 1.

In this event, the spring elements 7 may be configured to have different spring constants in the vicinity of the kiss point.

As another form, load (pressure) may be load of a cushion spring (pressure) when the discs 3 and the plates 5 are first fastened according to the compression of the spring element 7 having the smallest spring constant.

In this event, the spring elements 7 may be configured to have different spring constants at the load level of the cushion spring.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A friction element for a transmission, comprising:
a multi-plate disc set configured to vary frictional force between a plurality of discs and a plurality of plates based on operation of a piston; and
a sequential fastening means configured to sequentially fasten the plurality of discs and the plurality of plates based on the operation of the piston.

2. The friction element of claim 1, wherein the sequential fastening means includes spring elements respectively installed between neighboring discs of the plurality of discs or between neighboring plates of the plurality of plates, and the spring elements have different spring constants.

3. The friction element of claim 2, wherein each of the spring elements has ends respectively supported by facing sides of two plates of the neighboring plates.

4. The friction element of claim 2, wherein each of the spring elements has ends respectively supported by facing sides of two discs of the neighboring discs.

5. The friction element of claim 2, wherein gaps between the plurality of plates are uniform in a state in which an operation force of the piston is not transferred to the multi-plate disc set.

6. A friction element for a transmission, comprising:
a multi-plate disc set having a plurality of discs and a plurality of plates operable to engage each other with a frictional force;
a piston configured to vary the frictional force between the plurality of discs and the plurality of plates; and
a plurality of spring elements respectively installed between neighboring discs of the plurality of discs or between neighboring plates of the plurality of plates, wherein the spring elements have different spring constants.

7. The friction element of claim 6, wherein each of the spring elements has ends respectively supported by facing sides of two plates of the neighboring plates.

8. The friction element of claim 6, wherein each of the spring elements has ends respectively supported by facing sides of two discs of the neighboring discs.

9. The friction element of claim 6, wherein the spring elements are installed so that gaps between the plurality of plates or the plurality of discs are identical when the piston is not operated.

10. The friction element of claim 6, wherein the spring elements are configured so that an amount of a change in a stroke of the piston with respect to an increase in an operation force of the piston sequentially decreases.
